(19) United States
(12) Patent Application Publication
(10) Pub. No.: US 2021/0049620 A1
(43) Pub. Date: Feb. 18, 2021

(54) BLOCKCHAIN BASED MOBILE TERMINAL E-COMMERCE SYSTEM AND MOBILE TERMINAL

(71) Applicant: SHANGHAI SUOBEI INFORMATION TECHNOLOGY CO., LTD., Shanghai (CN)

(72) Inventor: DAOLI LI, Wenzhou (CN)

(21) Appl. No.: 16/745,395

(22) Filed: Jan. 17, 2020

(30) Foreign Application Priority Data
Aug. 16, 2019 (CN) 201910759916.8

(51) Int. Cl. G06Q 30/02; H04L 9/06

(52) U.S. Cl. CPC G06Q 30/0201; G06Q 30/0219; H04L 2209/56; H04L 9/0643; H04L 2209/38; G06Q 30/0222

(57) ABSTRACT

A blockchain based mobile terminal e-commerce system and a mobile terminal, the blockchain based mobile terminal e-commerce system comprising: a transaction management unit and a blockchain unit; wherein the transaction management unit is configured to generate a transaction record for each transaction; the blockchain unit comprises: a ledger generation unit, a reward generation unit and a block recording unit; and the mobile terminal comprises: a mining command receiving unit, a mining unit and a mining exit unit. in the present invention, a blockchain is combined with an e-commerce system, and mining is performed by a mobile terminal, that is, the mobile terminal performs ledger recording and packs records into a new block, then links the new block to a blockchain store, thereby reducing the computing load of a central server, guarantying the authenticity of the transaction ledger recording result, and realizing a mobile terminal mining function.

### CROSS-REFERENCE TO PRIOR APPLICATION

This application claims the benefit of Chinese Patent Application No. 201910759916.8 filed on Aug. 16, 2019, the contents of which are incorporated herein by reference.

### TECHNICAL FIELD

The present invention relates to the technical field of electronic commerce, and particularly to a blockchain based mobile terminal e-commerce system and a mobile terminal.

### BACKGROUND ART

Electronic commerce, briefly referred to as e-commerce, refers to transaction activities and related service activities conducted by means of electronic transactions on the Internet, Intranet and Value Added Network (VAN), thereby realizing the electronization and networkization of various stages of traditional commercial activities. In a traditional e-commerce system, a large number of transaction records are generated during transactions. Especially in a larger scaled e-commerce system, there are thousands of transactions every second. These transaction records are recorded and stored collectively by a central server of the e-commerce system, which greatly increases the computing load of the central server. Moreover, the centralized database of the traditional e-commerce system has problems that the data is easy to be tampered with and the authenticity of the data cannot be guaranteed, for example: in the traditional e-commerce system, there exists situations such as modifying the transaction times of a certain product.

### SUMMARY OF THE INVENTION

The present invention proposes a blockchain based mobile terminal e-commerce system and a mobile terminal, which solves the problems of heavy computing load on the central server of an e-commerce system and unguaranteed authenticity of transaction records.

A blockchain based mobile terminal e-commerce system of the present invention comprises: a transaction management unit and a blockchain unit; wherein
the transaction management unit is configured to generate a transaction record for each transaction;
the blockchain unit comprises:
a ledger generation unit configured to generate a ledger from the transaction records that can be processed by any participating user, and add the ledger to a mining area so as to carry out mining by a mobile terminal that is currently online;
a reward generation unit configured to generate, for a new block generation task-related calculation problem, a corresponding bonus, and distribute the bonus to a mobile terminal that first works out the calculation problem and packs ledger recording results of the ledger to generate a new block; and
a block recording unit configured to link the new block to a blockchain.

The reward generation unit is specifically configured to generate a bonus in a certain proportion to the transaction amount in each transaction.

The blockchain unit further comprises: a mining area maintenance unit configured to make a real time statistics on the total transaction amount traded in the mining area and an accumulated bonus amount, and push the total transaction amount and the accumulated bonus amount to the mobile terminal for display.

The mining area maintenance unit is further configured to push the user name of a mobile terminal that has completed the task of generating a new block, and a message of obtaining a corresponding bonus to mobile terminals that are currently online.

The present invention also provides a blockchain based mobile terminal, comprising:
a mining command receiving unit configured to receive a mining command input by a user and link a mining area;
a mining unit configured to works out a calculation problem related to a new block generation task in the mining area, generate a new block after the calculation problem is worked out first, record ledger recording results of a ledger in the new block, and acquire a bonus; and
a mining exit unit configured to receive a mining exit command from the user and exit mining.

The mining exit unit is further configured to acquire electric quantity information of the mobile terminal in real time, and automatically exit mining when the electric quantity information is below a preset electric quantity value.

The mining exit unit is further configured to monitor a temperature value of the mobile terminal in real time, and automatically exit mining when the temperature value exceeds a preset temperature value.

In the blockchain based mobile terminal e-commerce system of the present invention, transaction records are processed into a ledger that can be processed by any participating user. The ledger is distributed to a mining area based on the blockchain principle, and a mobile terminal performs ledger recording in a manner of mining and obtains a corresponding bonus, thereby realizing the function of mining at the mobile terminal. Each mobile terminal participates in ledger recording and retains a copy of ledger recording data, and a new block is generated by a mobile terminal that first works out the calculation problem, and is stored in the blockchain, thereby enabling decentralized storage, and the transaction records are not easy to be tampered with, thus guarantying the authenticity of the transaction records. Moreover, the ledger recording is processed by mobile terminals, which greatly reduces the computing load of the central server.

### BRIEF DESCRIPTION OF THE DRAWINGS

In order to illustrate the technical solutions in the embodiments of the present invention or in the prior art more clearly, a brief introduction to the figures to be used in the description of the embodiments or the prior art will be provided below. Obviously, the drawings in the following description show merely some embodiments of the present invention, and those of ordinary skills in the art would have derived other drawings from these drawings without any creative effort.

FIG. 1 is a schematic structural diagram of a blockchain based mobile terminal e-commerce system according to the present invention.

FIG. 2 is a schematic structural diagram of a mobile terminal according to the present invention.

### DETAILED DESCRIPTION OF EMBODIMENTS

The technical solution of the embodiments of the present invention will be clearly and completely described below in conjunction with the accompanying drawings for the embodiments of the present invention; and obviously, the embodiments described are merely some, rather than all, of the embodiments of the present invention. On the basis of the embodiments of the present invention, all the other embodiments obtained by those of ordinary skill in the art without creative efforts shall fall within the scope of protection of the present invention.

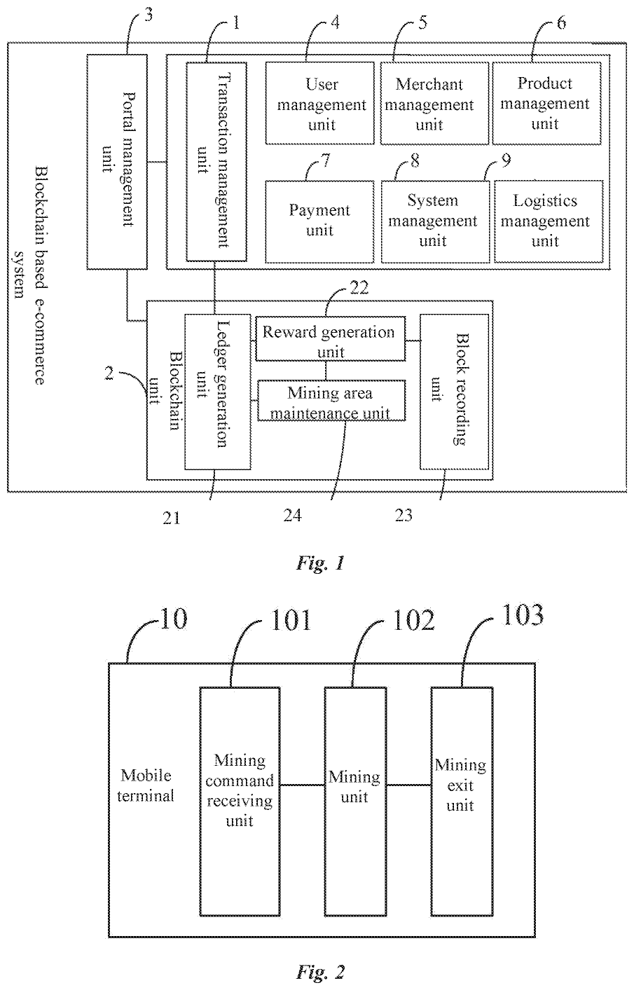

In an embodiment, the present invention provides a blockchain based mobile terminal e-commerce system, as shown in FIG. 1, which specifically comprises: a transaction management unit 1 and a blockchain unit 2.

The transaction management unit is configured to generate a transaction record for each transaction. When a user makes an online purchase through a mobile terminal, a transaction is generated, then the transaction management unit 1 generates a transaction record for the transaction, in order to increase the utilization of block storage and reduce redundant information, the transaction record including: buyer information and seller information, such as: the respective IDs and addresses of the buyer and seller.

The blockchain unit 2 comprises:
a ledger generation unit 21 configured to generate a ledger from the transaction records that can be processed by any participating user, and add the ledger to a mining area so as to carry out mining by a mobile terminal (e.g. a mobile phone) that is currently online. The mining area includes ledgers that are newly generated within a period of time and have not been packed into a block and uploaded to the chain. Over time, the number of ledgers in the mining area also varies, the mobile terminal performs mining by being linked to the mining area, and a display interface of the mining area can be pushed to the mobile terminal for display through a portal management unit 3 at the front end of the system.

A reward generation unit 22 is configured generate, for a new block generation task-related calculation problem, a corresponding bonus, and distribute the bonus to a mobile terminal that first works out the calculation problem and packs ledger recording results of the ledger to generate a new block. The purpose of mobile terminal to perform mining is to obtain a bonus. Therefore, a corresponding bonus is set for and a calculation problem is associated with the task of generating a new block. The mobile terminal that first works out the calculation problem obtains the bonus, and that mobile terminal generates a new block and packs ledger recording results of several ledgers into the new block until the capacity of the new block reaches the upper limit.

A block recording unit 23 is configured to link the new block to the blockchain, i.e. the process of uploading a new block to the chain.

In this embodiment, in the blockchain based mobile terminal e-commerce system, transaction records are processed into a ledger that can be processed by any participating user. The ledger is distributed to a mining area based on the blockchain principle, and a mobile terminal perform, ledger recording in a manner of mining and obtains a corresponding bonus, thereby realizing the function of mining at the mobile terminal. Each mobile terminal participates in ledger recording and retains a copy of ledger recording data, and a new block is generated by a mobile terminal that first works out the calculation problem, and is stored in the blockchain, thereby enabling decentralized storage, and the transaction records are not easy to be tampered with, thus guarantying the authenticity of the transaction records. Moreover, the ledger recording is processed by mobile terminals, which greatly reduces the computing load of the central server.

The reward generation unit 22 is specifically configured to generate a bonus in a certain proportion to the transaction amount in each transaction, for example, 0.5%˜1% of the transaction amount. The proportion varies according to the different transaction amounts, and can be set according to the actual situation. This is equivalent to taking a small portion of the seller's profit as a bonus and distributing it to the mobile terminal that generates the new block. That is, as long as a transaction occurs, a bonus will be generated, which does not affect the seller's profit, and can continuously reward the mobile terminal that performs block packing with a bonus. In the new block generated, depending on how many ledger recording results of the ledger are packed, the bonus is the sum of the corresponding proportions of the transaction amounts of the corresponding transactions in the ledger.

In this embodiment, the blockchain unit 2 further comprises: a mining area maintenance unit 24 configured to make a real time statistics on the total transaction amount traded in the mining area and an accumulated bonus amount, and push the total transaction amount and the accumulated bonus amount to the mobile terminal for display. Specifically, the mining area maintenance unit 24 displays the total transaction amount and the total bonus amount in real time and respectively on the top of the mining area interface through the portal management unit 3, and the mining user can see the changes in the total transaction amount and the total bonus amount in the mining area.

Further, the mining area maintenance unit 24 is further configured to push the user name of a mobile terminal that has completed the task of generating a new block and the corresponding obtained bonus to mobile terminals that are currently online. Specifically, the portal management unit 3 pushes the user name of a mobile terminal that has obtained the bonus within a certain period of time, and the corresponding obtained bonus to the mining area interface of each mobile terminal that is currently online for scrolling display, so as to let users know the authenticity of mining. Of course, the substantial benefits brought to the users by these rewards can also be displayed, in order to arouse the users' interest of use and bring the users a new participatory shopping experience, thereby increasing the user's willingness to use and disseminate.

Of course, the blockchain based mobile terminal e-commerce system in this embodiment is similar to the traditional e-commerce system, and also comprises: functional units such as a portal management unit 3, a user management unit 4, a merchant management unit 5, a product management unit 6, a payment unit 7, a system management unit 8, and a logistics management unit 9. The above functional units and corresponding functional units in the traditional e-commerce systems is similar, for example: the blockchain based mobile terminal e-commerce system also displays shopping products and related information on an APP homepage in the mobile terminal through the portal management unit 3 at the front end, which is not repeated herein. The blockchain based mobile terminal e-commerce system in this embodiment should ensure a certain degree of centralization, mainly aiming to improve the system's ability to resist risks. Only ledger recording results of the most core transaction records are retained in the blockchain. Data corresponding to the above functional units, such as: external user data, merchant data, and product data are saved and processed by the system's central server, instead of being saved on the blockchain, reducing redundant data. Blockchain is a trust mechanism. The data on the blockchain is open and transparent, and everyone can see it, and everyone can query it at any time.

In another embodiment, the present invention provides a blockchain based mobile terminal 10, as shown in FIG. 2, which comprises:
a mining command receiving unit 101 configured to receive a mining command input by a user and link a mining area. Specifically, an APP interface of a mobile terminal which is online will display a graphical button for participating in mining. If the user wants to participate in mining, he/she can directly click the graphical button.

A mining unit 102 is configured to work out a calculation problem related to a new block generation task in the mining area, generate a new block after the calculation problem is worked out first, record ledger recording results of a ledger in the new block, and acquire a bonus. After the new block is generated, the block recording unit 23 of the above blockchain based mobile terminal e-commerce system will be requested to link the new block to the blockchain.

A mining exit unit 103 is configured to receive a mining exit command from the user and exit mining. Specifically, after the user clicks the graphical button for participating in mining, the graphical button will change to a graphical button for stopping mining or exiting mining, and the user will exit mining after clicking the graphical button.

The blockchain based mobile terminal 10 in this embodiment has a mining function. Compared with a mobile terminal in the traditional e-commerce system, it shares the ledger recording task of the central server of the e-commerce system, which greatly reduces the burden of the central server of the e-commerce system. Moreover, a new block is generated based on the recorded ledger and is linked to the existing blockchain, so that the transaction records are not easy to be tampered with, and the authenticity of the transaction records is guaranteed. At the same time, the mining mechanism of the mobile terminal can bring more attention, greater influence and popularity, and increase the market share of the blockchain based mobile terminal e-commerce system.

Due to the limited electric quantity of the mobile terminal 10, in order to avoid interruption in the mining process, the mining exit unit 103 is further configured to acquire electric quantity information of the mobile terminal 10 in real time, and automatically exit mining when the electric quantity information is below a preset electric quantity value (e.g. 10% of the total electric quantity).

The mobile terminal 10 is not a dedicated mining machine. It must also take into account normal use while mining. When multiple programs are running simultaneously or for a long time, the mining program will cause heat generation. Since its heat dissipation is not as good as the dedicated mining machine, its computational performance may be degraded dramatically. Therefore, the mining exit unit 103 is further configured to monitor the temperature value of the mobile terminal 10 in real time, and automatically exit mining after the temperature value exceeds a preset temperature value.

The above embodiments are merely preferred embodiments of the present invention but not intended to limit the present invention, and any modifications, equivalent replacements, improvements, etc. made within the spirit and principle of the present invention should be included within the scope of protection of the present invention.

1. A blockchain based mobile terminal e-commerce system, comprising: a transaction management unit and a blockchain unit; wherein
the transaction management unit is configured to generate a transaction record for each transaction;
the blockchain unit comprises:
a ledger generation unit configured to generate a ledger from the transaction records that can be processed by any participating user, and add the ledger to a mining area so as to carry out mining by a mobile terminal that is currently online;
a reward generation unit configured to generate, for a new block generation task-related calculation problem, a corresponding bonus, and distribute the bonus to a mobile terminal that first works out the calculation problem and packs ledger recording results of the ledger to generate a new block; and
a block recording unit configured to link the new block to a blockchain.

2. The blockchain based mobile terminal e-commerce system of claim 1, wherein the reward generation unit is specifically configured to generate a bonus in a certain proportion to the transaction amount in each transaction.

3. The blockchain based mobile terminal e-commerce system of claim 1, wherein the blockchain unit further comprises: a mining area maintenance unit configured to make a real time statistics on the total transaction amount traded in the mining area and an accumulated bonus amount, and push the total transaction amount and the accumulated bonus amount to the mobile terminal for display.

4. The blockchain based mobile terminal e-commerce system of claim 3, wherein the mining area maintenance unit is further configured to push the user name of a mobile terminal that has completed the task of generating a new block, and a message of obtaining a corresponding bonus to mobile terminals that are currently online.

5. A blockchain based mobile terminal, comprising:
a mining command receiving unit configured to receive a mining command input by a user and link a mining area;
a mining unit configured to works out a calculation problem related to a new block generation task in the mining area, generate a new block after the calculation problem is worked out first, record ledger recording results of a ledger in the new block, and acquire a bonus; and
a mining exit unit configured to receive a mining exit command from the user and exit mining.

6. The blockchain based mobile terminal of claim 1, wherein the mining exit unit is further configured to acquire electric quantity information of the mobile terminal in real time, and automatically exit mining when the electric quantity information is below a preset electric quantity value.

7. The blockchain based mobile terminal of claim 1, wherein the mining exit unit is further configured to monitor a temperature value of the mobile terminal in real time, and automatically exit mining when the temperature value exceeds a preset temperature value.
